(19) United States
(12) Patent Application Publication
(10) Pub. No.: US 2025/0089935 A1
(43) Pub. Date: Mar. 20, 2025

(54) COOKING DEVICE, CONTROL METHOD AND APPARATUS THEREOF, AND COMPUTER-READABLE STORAGE MEDIUM

(71) Applicant: GUANGDONG MIDEA KITCHEN APPLIANCES MANUFACTURING CO., LTD., FOSHAN (CN)

(72) Inventors: Tianyi LIU, FOSHAN (CN); Zhi ZHANG, FOSHAN (CN); Peiyao ZHANG, FOSHAN (CN); Xiaojiang CHEN, FOSHAN (CN); Xu LU, FOSHAN (CN); Shuangxia YUAN, FOSHAN (CN); Xiaohua ZHANG, FOSHAN (CN)

(21) Appl. No.: 18/293,318

(22) PCT Filed: Aug. 10, 2023
(86) PCT No.: PCT/CN2023/112293

§ 371 Date: Jan. 29, 2024

(30) Foreign Application Priority Data
May 31, 2023 (CN) 202310644799.7
May 31, 2023 (CN) 202310644823.7
May 31, 2023 (CN) 202310644853.8

(51) Int. Cl. A47J 36/32; H05B 6/68

(52) U.S. Cl. CPC A47J 36/321; H05B 6/68

(57) ABSTRACT

Provided are a cooking device, a control method and apparatus thereof, and a computer-readable storage medium. The cooking device includes an air frying module and a microwave module. The method includes: obtaining a characteristic parameter of a food material and a cooking stage of the cooking device; determining a cooking parameter of the cooking device based on the characteristic parameter of the food material; and controlling the air frying module or the microwave module based on the cooking stage and the cooking parameter to accelerate cooking of the food material.

### CROSS-REFERENCES TO RELATED APPLICATIONS

The present disclosure is a national phase application of International Application No. PCT/CN2023/112293, filed on Aug. 10, 2023, which claims priority to Chinese patent applications Nos. 202310644823.7, 202310644799.7, and 202310644853.8, filed on May 31, 2023, the entire contents of which are incorporated herein by reference.

### FIELD

The present disclosure relates to the field of cooking control technologies, and more particularly, to a cooking device, a control method and apparatus thereof, and a computer-readable storage medium.

### BACKGROUND

Frying is a traditional and fast food processing method widely used in home and commercial cooking. Fried food is popular for its appealing appearance and its crispy exterior and tender interior texture. However, the fried food also has a high content of fat and prone to produce harmful substances during cooking.

Air frying is a new cooking method that uses hot air instead of oil as a heat transfer medium. In a frying process, no use or less use of oil not only greatly reduces an oil content of food, but also retains nutrients. However, because air has a heat transfer coefficient smaller than a heat transfer coefficient of the oil, changes in a temperature, moisture, and a color of food in an air frying process are slower than changes in the frying process, resulting in a lower moisture loss inside the food, leading to an overall soft crust of food, a poor encrustation effect, and a long cooking time period.

### SUMMARY

The present disclosure aims to solve, at least one of the problems in the related art to some extent. Embodiments of the present disclosure are to provide a control method for a cooking device, to enhance a dehydration rate of a food material, further accelerating cooking of the food material, and shortening a cooking time period, to achieve a cooking effect of the food material with a crispy exterior and tender interior, and thus to improve user experience.

One embodiment of the present disclosure is to provide a computer-readable storage medium.

One embodiment of the present disclosure is to provide a cooking device.

One embodiment of the present disclosure is to provide a control apparatus for a cooking device.

In order to achieve the above-mentioned embodiments of the present disclosure provide a control method for a cooking device. The cooking device includes an air frying module and a microwave module. The method includes: obtaining a characteristic parameter of a food material and a cooking stage of the cooking device; determining a cooking parameter of the cooking device based on the characteristic parameter of the food material; and controlling the air frying module or the microwave module based on the cooking stage and the cooking parameter to accelerate cooking of the food material.

In the control method for the cooking device according to the embodiments of the present disclosure, by controlling the air frying module or the microwave module based on the cooking stage and the cooking parameter, the dehydration rate of the food material can be enhanced, cooking of the food material is further accelerated, and the cooking time period is shortened, to achieve the cooking effect of the food material with the crispy exterior and tender interior, and thus to improve the user experience.

In addition, the control method for the cooking device according to the above-mentioned embodiments of the present disclosure may further include additional features as follows.

According to an embodiment of the present disclosure, the characteristic parameter of the food material includes a type and a weight of the food material; the cooking parameter includes predetermined cooking power, a predetermined cooking temperature, a total cooking time period, and a cavity temperature of the cooking device; and the cooking stage includes a microwave quick-heating stage, an air-frying temperature rise stage, and a browning and crusting stage.

According to an embodiment of the present disclosure, the controlling the air frying module or the microwave module based on the cooking stage and the cooking parameter includes, when the cooking stage is the microwave quick-heating stage: determining a first predetermined cooking time period at the microwave quick-heating stage, and determining first predetermined cooking power at the microwave quick-heating stage based on the type of the food material; and controlling the microwave module to operate at the first predetermined cooking power for the first predetermined cooking time period.

According to an embodiment of the present disclosure, the first predetermined cooking power ranges from 200 W to 1400 W; and the first predetermined cooking time period ranges from 15% t to 35% t, where t represents the total cooking time period.

According to an embodiment of the present disclosure, the controlling the air frying module or the microwave module based on the cooking stage and the cooking parameter includes, when the cooking stage is the air-frying temperature rise stage: determining a first predetermined cooking temperature and a second predetermined cooking time period at the air-frying temperature rise stage; obtaining a cavity temperature of the cooking device; and controlling the air frying module based on the cavity temperature, the first predetermined cooking temperature and the second predetermined cooking time period.

According to an embodiment of the present disclosure, the controlling the air frying module based on the cavity temperature, the first predetermined cooking temperature and the second predetermined cooking time period includes, in the second predetermined cooking time period: controlling the air frying module to operate when the cavity temperature is smaller than or equal to a difference between the first predetermined cooking temperature and a first temperature threshold; and prohibiting the air frying module from operating when the cavity temperature is greater than or equal to a sum of the first predetermined cooking temperature and the first temperature threshold.

According to an embodiment of the present disclosure, the first predetermined cooking temperature ranges from 160° C. to 260° C.; and the second predetermined cooking time period ranges from 40% t to 65% t, where t represents the total cooking time period.

According to an embodiment of the present disclosure, the method further includes, subsequent to completion of the controlling the air frying module based on the cavity temperature, the first predetermined cooking temperature and the second predetermined cooking time period: switching the cooking stage to the browning and crusting stage.

According to an embodiment of the present disclosure, the controlling the air frying module or the microwave module based on the cooking stage and the cooking parameter includes, when the cooking stage is the browning and crusting stage: determining a second predetermined cooking temperature and a third predetermined cooking time period at the browning and crusting stage; obtaining a cavity temperature of the cooking device; and controlling the air frying module based on the cavity temperature, the second predetermined cooking temperature and the third predetermined cooking time period.

According to an embodiment of the present disclosure, the controlling the air frying module based on the cavity temperature, the second predetermined cooking temperature and the third predetermined cooking time period includes, in the third predetermined cooking time period: controlling the air frying module to operate when the cavity temperature is smaller than or equal to a difference between the second predetermined cooking temperature and a second temperature threshold; and prohibiting the air frying module from operating when the cavity temperature is greater than or equal to a sum of the second predetermined cooking temperature and the second temperature threshold.

According to an embodiment of the present disclosure, the second predetermined cooking temperature ranges from 140° C. to 250° C.; and the third predetermined cooking time period ranges from 15% t to 40% t, where t represents the total cooking time period.

According to an embodiment of the present disclosure, the method further includes, subsequent to completion of the controlling the air frying module based on the cavity temperature, the second predetermined cooking temperature and the third predetermined cooking time period: switching the cooking stage to the microwave quick-heating stage.

According to an embodiment of the present disclosure, the cooking stage further includes a cavity temperature rise stage; and the controlling the air frying module or the microwave module based on the cooking stage and the cooking parameter includes, when the cooking stage is the cavity temperature rise stage: determining a third predetermined cooking temperature and a fourth predetermined cooking time period at the cavity temperature rise stage; obtaining a cavity temperature of the cooking device; and controlling the air frying module based on the cavity temperature, the third predetermined cooking temperature and the fourth predetermined cooking time period.

According to an embodiment of the present disclosure, the controlling the air frying module based on the cavity temperature, the third predetermined cooking temperature and the fourth predetermined cooking time period includes, in the fourth predetermined cooking time period: controlling the air frying module to operate when the cavity temperature is smaller than or equal to a difference between the third predetermined cooking temperature and a third temperature threshold; and prohibiting the air frying module from operating when the cavity temperature is greater than or equal to a sum of the third predetermined cooking temperature and the third temperature threshold.

According to an embodiment of the present disclosure, the third predetermined cooking temperature ranges from 80° C. to 250° C.; and the fourth predetermined cooking time period ranges from 20% t to 35% t, where t represents the total cooking time period.

According to an embodiment of the present disclosure, a cooking time period in the air-frying temperature rise stage ranges from 20% t to 30% t, where t represents the total cooking time period.

According to an embodiment of the present disclosure, the total cooking time period is determined based on the weight of the food material and ranges from 8 min to 40 min.

In order to achieve the above-mentioned embodiments of the present disclosure provide a computer-readable storage medium. The computer-readable storage medium has a control program for a cooking device stored thereon. The control program for the cooking device, when executed by a processor, implements the above-mentioned control method for the cooking device.

The computer-readable storage medium according to the embodiments of the present disclosure can enhance the dehydration rate of the food material, further accelerate cooking of the food material, and shorten the cooking time period, to achieve the cooking effect of the food material with the crispy exterior and tender interior, and thus to improve the user experience.

In order to achieve the above-mentioned embodiments of the present disclosure provide a cooking device. The cooking device includes: a memory; a processor; and a control program for a cooking device stored on the memory and executable on the processor. The processor, when executing the control program, implements the above-mentioned control method for the cooking device.

The cooking device according to the embodiments of the present disclosure can enhance the dehydration rate of the food material, further accelerate cooking of the food material, and shorten the cooking time period, to achieve the cooking effect of the food material with the crispy exterior and tender interior, and thus to improve the user experience.

In order to achieve the above-mentioned embodiments of the present disclosure provide a control apparatus for a cooking device. The cooking device includes an air frying module and a microwave module. The device includes an obtaining module, a determining module, and a control module. The obtaining module is configured to obtain a characteristic parameter of a food material and a cooking stage of the cooking device. The determining module is configured to determine a cooking parameter of the cooking device based on the characteristic parameter of the food material. The control module is configured to control the air frying module or the microwave module based on the cooking stage and the cooking parameter to accelerate cooking of the food material.

The control apparatus according to the embodiments of the present disclosure can enhance the dehydration rate of the food material, further accelerate cooking of the food material, and shorten the cooking time period, to achieve the cooking effect of the food material with the crispy exterior and tender interior, and thus to improve the user experience.

Additional embodiments of present disclosure will be provided at least in part in the following description, or will become apparent in part from the following description, or will be learned from the practice of the embodiments of the present disclosure.

### BRIEF DESCRIPTION OF THE DRAWINGS

FIG. 1 is a block diagram of a cooking device according to an embodiment of the present disclosure.

FIG. 2 is a flowchart of a control method for a cooking device according to an embodiment of the present disclosure.

FIG. 3 is a flowchart of a control method for a cooking device according to another embodiment of the present disclosure.

FIG. 4 is a flowchart of a control method for a cooking device according to another embodiment of the present disclosure.

FIG. 5 is a flowchart of a control method for a cooking device according to another embodiment of the present disclosure.

FIG. 6 is a flowchart of a control method for a cooking device according to another embodiment of the present disclosure.

FIG. 7 is a block diagram of a cooking device according to another embodiment of the present disclosure.

FIG. 8 is a flowchart of a control apparatus for a cooking device according to an embodiment of the present disclosure.

### DETAILED DESCRIPTION OF THE DISCLOSURE

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain rather than limit the present disclosure.

A control method for a cooking device, a computer-readable storage medium, a cooking device, and a control apparatus for a cooking device according to embodiments of the present disclosure are described below with reference to the accompanying drawings.

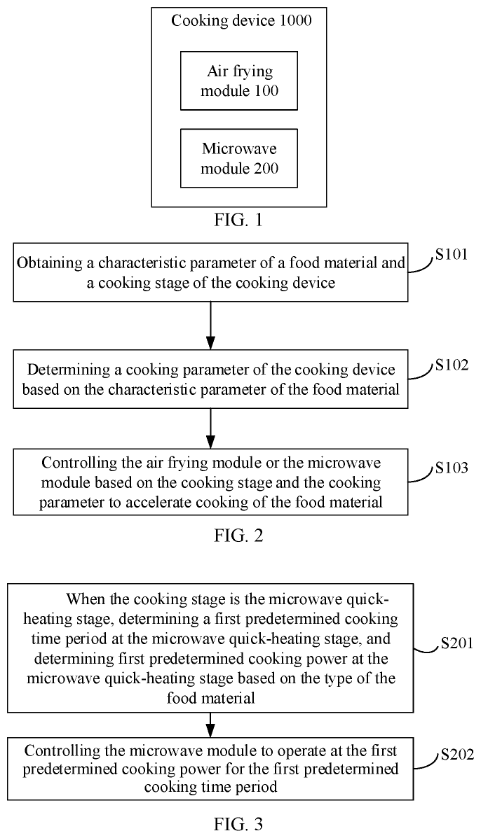

In an exemplary embodiment of the present disclosure, as illustrated in FIG. 1, a cooking device 1000 includes an air fry module 100 and a microwave module 200. Both the air fry module 100 and the microwave module 200 are for cooking a food material. The present disclosure cooks the food material by controlling cooperative operation between the air fry module 100 and the microwave module 200, to shorten a cooking time period while improving a cooking effect.

FIG. 2 is a flowchart of a control method for a cooking device according to an embodiment of the present disclosure.

In some embodiments of the present disclosure, as illustrated in FIG. 2, the control method for the cooking device includes following actions at steps S101 to S103.

At step S101, a characteristic parameter of a food material and a cooking stage of the cooking device are obtained.

In this embodiment, the characteristic parameter of the food material includes a type and a weight of the food material. The type and the weight of the food material may be obtained by providing an intelligent sensor, or may be obtained manually by a user. For example, the type of the food material may be French fries, a chicken wing, a whole chicken, and a pork burger, etc. In addition, the present disclosure may not specifically limit the characteristic parameter of the food material and a manner of obtaining the characteristic parameter of the food material. The cooking stage includes a microwave quick-heating stage, an air-frying temperature rise stage, and a browning and crusting stage. The cooking stage of the cooking device for obtaining in this embodiment may be one of the microwave quick-heating stage, the air-frying temperature rise stage, and the browning and crusting stage.

In this embodiment, the characteristic parameter of the food material may also be changed to a specific menu based on a functional requirement of the cooking device, such as a whole pork chop, a lamb chop, and a Wellington steak, etc. Then, a to-be-cooked menu obtained by the user may be determined as the characteristic parameter of the food material, or a to-be-cooked menu obtained by the intelligent sensor may be determined as the characteristic parameter of the food material.

At step S102, a cooking parameter of the cooking device is obtained based on the characteristic parameter of the food material.

In this embodiment, the characteristic parameter of the food material includes a type and a weight of the food material, and the cooking parameter includes predetermined cooking power, a predetermined cooking temperature, a total cooking time period, and a cavity temperature of the cooking device. Then, the predetermined cooking power, the predetermined cooking temperature, the total cooking time period, and the cavity temperature of the cooking device may be determined based on the type and the weight of the food material.

It should be noted that the total cooking time period t is determined based on the weight of the food material, and ranges from 8 min to 40 min. Furthermore, the present disclosure may not specifically limit a value range of the total cooking time period.

At step S103, the air frying module or the microwave module is controlled based on the cooking stage and the cooking parameter to accelerate cooking of the food material.

In this embodiment, the air frying module or the microwave module is controlled based on the microwave quick-heating stage, the air-frying temperature rise stage, and the browning and crusting stage in the cooking stage, and the predetermined cooking power, the predetermined cooking temperature, the total cooking time period, and the cavity temperature of the cooking device in the cooking parameter, to accelerate cooking of the food material. The microwave module is controlled when the cooking stage is the microwave quick-heating stage, the air frying module is controlled when the cooking stage is the air-frying temperature rise stage, and the air frying module is controlled when the cooking stage is the browning and crusting stage.

Further, in some embodiments of the present disclosure, as illustrated in FIG. 3, the controlling the air frying module or the microwave module based on the cooking stage and the cooking parameter includes following actions at steps S201 and S202.

At step S201, when the cooking stage is the microwave quick-heating stage, a first predetermined cooking time period at the microwave quick-heating stage is determined, and first predetermined cooking power at the microwave quick-heating stage is determined based on the type of the food material.

In this embodiment, when the cooking stage is the microwave quick-heating stage, a first predetermined cooking time period t_1 may be determined based on the weight of the food material and ranges from 15% t to 35% t, where t represents a total cooking time period. First predetermined cooking power P_1 at the microwave quick-heating stage is determined based on the type of food material and ranges from 200 W to 1400 W. In addition, the present disclosure may not specifically limit specific values of the first predetermined cooking power P_1 and the first predetermined cooking time period t_1.

At step S202, the microwave module is controlled to operate at the first predetermined cooking power for the first predetermined cooking time period.

In this embodiment, if the type of the food material is French fries, the weight of the food material is 454 g, the total cooking time period t may, in some embodiments, be 28 min, and then the first predetermined cooking time period t_1 ranging from 4.2 min to 9.8 min may be obtained. The first predetermined cooking time period t_1 may, in some embodiments, be 6 min, the first predetermined cooking power P_1 may, in some embodiments, be 1000 W. Furthermore, the present disclosure may not specifically limit a value of the first predetermined cooking power P_1 within a value range. The microwave module is then controlled to operate at the first predetermined cooking power P_1 for the first predetermined cooking time period t_1 by means of the selected first predetermined cooking time period t_1 and the first predetermined cooking power P_1. Water molecules in the food material can be heated by controlling the microwave module at the microwave quick-heating stage. Therefore, a temperature of a center of the food material increases rapidly, and moisture in the center of the food material rapidly migrates towards a surface of the food material and is further vaporized.

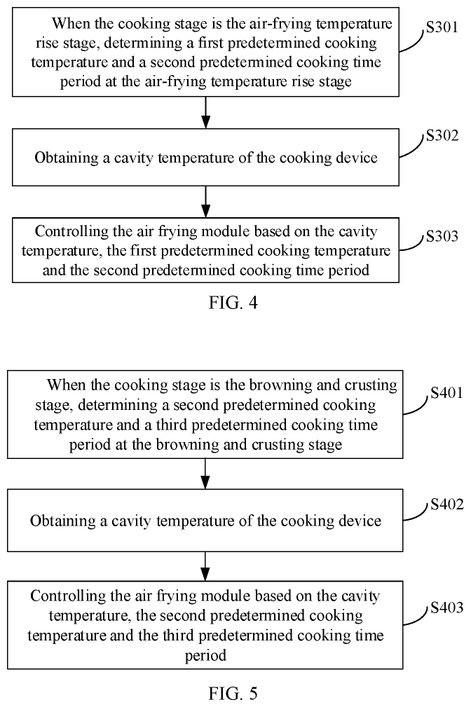

Further, in some embodiments of the present disclosure, as illustrated in FIG. 4, the controlling the air frying module or the microwave module based on the cooking stage and the cooking parameter includes following actions at steps S301 to S303.

At step S301, when the cooking stage is the air-frying temperature rise stage, a first predetermined cooking temperature and a second predetermined cooking time period at the air-frying temperature rise stage are determined.

In this embodiment, when the cooking stage is the air-frying temperature rise stage, a first predetermined cooking temperature T_1 at the air-frying temperature rise stage may be determined based on the type and the weight of the food material and ranges from 160° C. to 260° C. A second predetermined cooking time period t_2 is determined based on the weight of the food material and ranges from 40% t to 65% t, where t represents the total cooking time period.

At step S302, a cavity temperature of the cooking device is obtained.

In this embodiment, a cavity temperature T of the cooking device is a real-time temperature inside a cavity of the cooking device. In addition, a temperature sensor may be provided inside the cavity of the cooking device to obtain the cavity temperature T of the cooking device. Furthermore, the present disclosure may not specifically limit a manner of obtaining the cavity temperature T of the cooking device.

At step S303, the air frying module is controlled based on the cavity temperature, the first predetermined cooking temperature and the second predetermined cooking time period.

In this embodiment, in the second predetermined cooking time period t_2, the air frying module is controlled to operate when the cavity temperature T is smaller than or equal to a difference between the first predetermined cooking temperature T_1 and a first temperature threshold; and the air frying module is prohibited to operate when the cavity temperature T is greater than or equal to a sum of the first predetermined cooking temperature T_1 and the first temperature threshold. In addition, the air frying module is controlled to operate when the cavity temperature T is greater than the difference between the first predetermined cooking temperature T_1 and the first temperature threshold, and the cavity temperature T is smaller than the sum of the first predetermined cooking temperature T_1 and the first temperature threshold. The first temperature threshold may, in some embodiments, be 5° C. Furthermore, the present disclosure may not specifically limit a value of the first temperature threshold. A second predetermined cooking temperature T_2 may, in some embodiments, range from 160° C. to 260° C., and the second predetermined cooking time period t_2 may range from 40% t to 65% t, where t represents the total cooking time period. Embodiments of the present disclosure may not specifically limit a value range of the first predetermined cooking temperature T_1 and a value range of the second predetermined cooking time period t_2.

In this embodiment, if the type of the food material is French fries and the weight of the food material is 454 g, the total cooking time period t may, in some embodiments, be 28 min, and then the second predetermined cooking time period t_2 ranging from 11.2 min to 18.2 min may be obtained. The second predetermined cooking time period t_2 may, in some embodiments, be 16 min, the first predetermined cooking temperature T_1 may, in some embodiments, be 210° C., and the first temperature threshold may, in some embodiments, be 5° C. The cavity temperature T may be obtained in real time by the temperature sensor disposed in the cavity of the cooking device. When the obtained cavity temperature T is 200° C., it means that the cavity temperature T is smaller than or equal to the difference between the first predetermined cooking temperature T_1 and the first temperature threshold. Then, the air frying module is controlled to operate by means of the selected first predetermined cooking temperature T_1 and the second predetermined cooking time period t_2. When the obtained cavity temperature T is 220° C., it means that the cavity temperature T is greater than or equal to the sum of the first predetermined cooking temperature T_1 and the first temperature threshold. Then, the air frying module is prohibited from operating at the obtained cavity temperature T. When the obtained cavity temperature T is 209° C., it means that the cavity temperature T is greater than the difference between the first predetermined cooking temperature T_1 and the first temperature threshold, and the cavity temperature T is smaller than the sum of the first predetermined cooking temperature T_1 and the first temperature threshold. Then, the air frying module is controlled to operate by means of the selected first predetermined cooking temperature T_1 and the second predetermined cooking time period t_2. The control of the air frying module at the air-frying temperature quick rise stage can rapidly raise the cavity temperature and maintain a higher temperature inside the cavity, which in turn promotes further dispersion of the moisture from the center of the food material spreading to the surface of the food material into the air and accelerates moisture loss of the food material.

In some embodiments of the present disclosure, after the control of the air-frying temperature rise stage is completed, the cooking stage may be further switched to the browning and crusting stage, to dehydrate the surface of the food material and improve a crusting effect on the surface of the food material. As illustrated in FIG. 5, in the browning and crusting stage, the controlling the air fry module or the microwave module based on the cooking stage and the cooking parameter includes following actions at steps S401 to S403.

At step S401, when the cooking stage is the browning and crusting stage, a second predetermined cooking temperature and a third predetermined cooking time period at the browning and crusting stage are determined.

In this embodiment, when the cooking stage is the browning and crusting stage, a second predetermined cooking temperature T_2 of the browning and crusting stage may be determined based on the type and the weight of the food material, and the second predetermined cooking temperature T_2 ranges from 140° C. to 250° C. A third predetermined cooking time period t_3 may be determined based on the weight of the food material, and the third predetermined cooking time period t_3 ranges from 15% t to 40% t, where t represents the total cooking time period.

At step S402, a cavity temperature of the cooking device is obtained.

In this embodiment, a cavity temperature T of the cooking device is a real-time temperature inside the cavity of the cooking device. In addition, a temperature sensor may be provided inside the cavity of the cooking device to obtain the cavity temperature T of the cooking device. Furthermore, the present disclosure may not specifically limit a manner of obtaining the cavity temperature T of the cooking device.

At step S403, the air frying module is controlled based on the cavity temperature, the second predetermined cooking temperature and the third predetermined cooking time period.

In this embodiment, in the third predetermined cooking time period t_3, the air frying module is controlled to operate when the cavity temperature T is smaller than or equal to a difference between the second predetermined cooking temperature T_2 and a second temperature threshold; and the air frying module is prohibited from operating when the cavity temperature T is greater than or equal to a sum of the second predetermined cooking temperature T_2 and the second temperature threshold. Further, the air frying module is controlled to operate when the cavity temperature T is greater than the difference between the second predetermined cooking temperature T_2 and the second temperature threshold, and the cavity temperature T is smaller than the sum of the second predetermined cooking temperature T_2 and the second temperature threshold. The second temperature threshold may, in some embodiments, be 5° C. In addition, the present disclosure may not specifically limit a value of the second temperature threshold. The second predetermined cooking temperature T_2 ranges from 140° C. to 250° C. A third predetermined cooking time period t_3 may be determined based on the weight of the food material, and the third predetermined cooking time period t_3 ranges from 15% t to 40% t, where t is the total cooking time period. Furthermore, the present disclosure may not specifically limit specific values of the second predetermined cooking temperature T_2 and the third predetermined cooking time period t_3.

In this embodiment, if the type of the food material is French fries and the weight of the food material is 454 g, the total cooking time period t may, in some embodiments, be 28 min. Then, the third predetermined cooking time period t_3 ranging from 4.2 min to 11.2 min may be obtained. The third predetermined cooking time period t_3 may, in some embodiments, be 6 min. The second predetermined cooking temperature T_2 may, in some embodiments, be 180° C. The second temperature threshold may, in some embodiments, be 5° C. The cavity temperature T may be obtained in real time by the temperature sensor disposed in the cavity of the cooking device. When the obtained cavity temperature T is 170° C., it means that the cavity temperature T is smaller than or equal to the difference between the second predetermined cooking temperature T_2 and the second temperature threshold. Then, the air frying module is controlled to operate by means of the selected second predetermined cooking temperature T_2 and the third predetermined cooking time period t_3. When the obtained cavity temperature T is 190° C., it means that the cavity temperature T is greater than or equal to the sum of the second predetermined cooking temperature T_2 and the second temperature threshold. Then, the air frying module is prohibited from operating by means of the obtained cavity temperature T. When the obtained cavity temperature T is 179° C., it means that the cavity temperature T is greater than the difference between the second predetermined cooking temperature T_2 and the second temperature threshold, and the cavity temperature T is smaller than the sum of the second predetermined cooking temperature T_2 and the second temperature threshold. Then, the air frying module is controlled to operate by means of the selected second predetermined cooking temperature T_2 and the third predetermined cooking time period t_3. By controlling the air frying module at the browning and crusting stage, the higher temperature in the cavity can be maintained, and the food material can be continuously heated to promote golden browning and crusting on the surface of the food material.

In some embodiments of the present disclosure, after the controlling of the browning and crusting stage is completed, the cooking stage may be further switched to the microwave quick-heating stage. The specific controlling of the microwave quick-heating stage may be referred to in the description of the above-mentioned embodiments, and details thereof are not repeated herein. The controlling of air frying at the microwave quick-heating stage can maintain the higher temperature in the cavity and continuously heat the food material, which in turn promotes the dispersion of the moisture on the surface of the food material into the air while crusting on the surface of the food material.

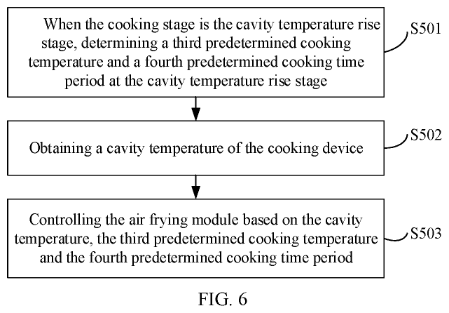

Further, in some embodiments of the present disclosure, the cooking stage further includes a cavity temperature rise stage, which may be completed prior to the microwave quick-heating stage. As illustrated in FIG. 6, the controlling the air frying module or the microwave module based on the cooking stage and the cooking parameter includes following actions at steps S501 to S503.

At step S501, when the cooking stage is the cavity temperature rise stage, a third predetermined cooking temperature and a fourth predetermined cooking time period at the cavity temperature rise stage are determined.

In this embodiment, when the cooking stage is the cavity temperature rise stage, a third predetermined cooking temperature T_3 of the cavity temperature rise stage may be determined based on the type and the weight of the food material, and the third predetermined cooking temperature T_3 ranges from 80° C. to 250° C. A fourth predetermined cooking time period t_4 may be determined based on the weight of the food material, and the fourth predetermined cooking time period t_4 ranges from 20% t to 35% t, where t represents the total cooking time period.

At step S502, a cavity temperature of the cooking device is obtained.

In this embodiment, the cavity temperature T of the cooking device is a real-time temperature inside the cavity of the cooking device. In addition, a temperature sensor may be provided inside the cavity of the cooking device to obtain the cavity temperature T of the cooking device. Furthermore, the present disclosure may not specifically limit a manner of obtaining the cavity temperature T of the cooking device.

At step S503, the air frying module is controlled based on the cavity temperature, the third predetermined cooking temperature and the fourth predetermined cooking time period.

In this embodiment, in the fourth predetermined cooking time period t_4, the air frying module is controlled to operate when the cavity temperature T is smaller than or equal to a difference between the third predetermined cooking temperature T_3 and a third temperature threshold; and the air frying module is prohibited from operating when the cavity temperature T is greater than or equal to a sum of the third predetermined cooking temperature T_3 and the third temperature threshold. In addition, the air frying module is controlled to operate when the cavity temperature T is greater than the difference between the third predetermined cooking temperature T_3 and the third temperature threshold, and the cavity temperature T is smaller than the sum of the third predetermined cooking temperature T_3 and the third temperature threshold. The third temperature threshold may, in some embodiments, be 5° C. Furthermore, the present disclosure may not specifically limit a value of the third temperature threshold. The third predetermined cooking temperature T_3 may, in some embodiments, range from 80° C. to 250° C., and the fourth predetermined cooking time period t_4 may, in some embodiments, range from 20% t to 35% t, where t represents the total cooking time period. Furthermore, the present disclosure may not specifically limit a value range of the third predetermined cooking temperature T_3 and a value range of the fourth predetermined cooking time period t_4.

In this embodiment, if the type of the food material is French fries and the weight of the food material is 454 g, the total cooking time period t may, in some embodiments, be 28 min. Then, the fourth predetermined cooking time period t_4 ranging from 5.6 min to 9.8 min may be obtained. The fourth predetermined cooking time period t_4 may, in some embodiments, be 7 min. The third predetermined cooking temperature T_3 may, in some embodiments, be 150° C. The third temperature threshold may, in some embodiments, be 5° C. The cavity temperature T may be obtained in real time by the temperature sensor disposed in the cavity of the cooking device. When the obtained cavity temperature T is 130° C., it means that the cavity temperature T is smaller than or equal to the difference between the third predetermined cooking temperature T_3 and the third temperature threshold. Then, the air frying module is controlled to operate by means of the third predetermined cooking temperature T_3 and the fourth predetermined cooking time period t_4. When the obtained cavity temperature T is 160° C., it means that the cavity temperature T is greater than or equal to the sum of the third predetermined cooking temperature T_3 and the third temperature threshold. Then, the air frying module is prohibited from operating by means of the obtained cavity temperature T. When the obtained cavity temperature Tis 148° C., it means that the cavity temperature T is greater than the difference between the third predetermined cooking temperature T_3 and the third temperature threshold, and the cavity temperature T is smaller than the sum of the third predetermined cooking temperature T_3 and the third temperature threshold. Then, the air frying module is controlled to operate by means of the selected third predetermined cooking temperature T_3 and the fourth predetermined cooking time period t_4. By controlling the air frying module at the cavity temperature rise stage, the temperature of the cavity can be rapidly raised, an ambient temperature of the cooking can be raised, and the temperature of the surface of the food material rises accordingly.

It should be noted that if the cooking stage includes the cavity temperature rise stage, i.e., if the cooking stage includes the four stages, namely, the cavity temperature rise stage, the microwave quick-heating stage, the air-frying temperature rise stage, and the browning and crusting stage, a cooking time period of the air-frying temperature rise stage may be adjusted to range from 20% t to 30% t, and cooking time periods of other stages are determined in accordance with the relevant description of the above embodiments. At last, a sum of time periods of the four cooking stages is determined as the total cooking time period.

In summary, in the control method for the cooking device according to the embodiments of the present disclosure, by controlling the air frying module or the microwave module based on the cooking stage and the cooking parameter, the dehydration rate of the food material can be enhanced, cooking of the food material can be further accelerated, and the cooking time period can be shorten, to achieve the cooking effect of the food material with the crispy exterior and tender interior, and thus to improve the user experience.

Based on the control method for the cooking device of the above-mentioned embodiments of the present disclosure, embodiments of the present disclosure further provide a computer-readable storage medium. The computer-readable storage medium has a control program for the cooking device stored thereon. The control program for the cooking device, when executed by a processor, implements the above-mentioned control method for the cooking device of the embodiments of the present disclosure.

In summary, the computer-readable storage medium according to the embodiments of the present disclosure can enhance the dehydration rate of the food material, further accelerate cooking of the food material, and shorten the cooking time period, to achieve the cooking effect of the food material with the crispy exterior and tender interior, and thus to improve the user experience.

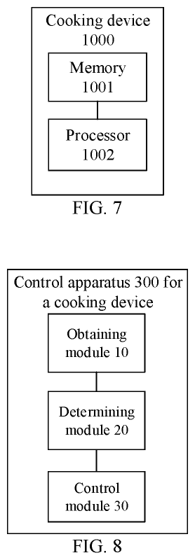

FIG. 7 is a block diagram of a cooking device according to another embodiment of the present disclosure.

Further, as illustrated in FIG. 7, based on the above-mentioned control method for the cooking device of the embodiments of the present disclosure, embodiments of the present disclosure further provide a cooking device 1000. The cooking device 1000 includes a memory 1001, a processor 1002, and a control program for the cooking device stored on the memory 1001 and executable on the processor 1002. The processor, when executing the control program, implements the above-mentioned control method of the embodiments of the present disclosure.

In summary, the cooking device according to the embodiments of the present disclosure can enhance the dehydration rate of the food material, further accelerate cooking of the food material, and shorten the cooking time period, to achieve the cooking effect of the food material with the crispy exterior and tender interior, and thus to improve the user experience.

In addition, other compositions and functions of the cooking device of the embodiments of the present disclosure are known, and details thereof are not repeated herein to reduce redundancy.

FIG. 8 is a block diagram of a control apparatus for a cooking device according to an embodiment of the present disclosure.

As illustrated in FIG. 8, a control apparatus 300 for the cooking device includes an obtaining module 10, a determining module 20, and a control module 30. The obtaining module 10 is configured to obtain a characteristic parameter of a food material and a cooking stage of the cooking device. The determining module 20 is configured to determine a cooking parameter of the cooking device based on the characteristic parameter of the food material. The control module 30 is configured to control the air frying module or the microwave module based on the cooking stage and the cooking parameter to accelerate cooking of the food material.

In some embodiments of the present disclosure, the characteristic parameter of the food material includes a type and a weight of the food material; the cooking parameter includes predetermined cooking power, a predetermined cooking temperature, a total cooking time period, and a cavity temperature of the cooking device; and the cooking stage includes a microwave quick-heating stage, an air-frying temperature rise stage, and a browning and crusting stage.

In some embodiments of the present disclosure, the control module 30 is configured to, when the cooking stage is the microwave quick-heating stage: determine a first predetermined cooking time period at the microwave quick-heating stage, and determine first predetermined cooking power at the microwave quick-heating stage based on the type of the food material; and control the microwave module to operate at the first predetermined cooking power for the first predetermined cooking time period.

In some embodiments of the present disclosure, the first predetermined cooking power ranges from 200 W to 1400 W; and the first predetermined cooking time period ranges from 15% t to 35% t, where t represents the total cooking time period.

In some embodiments of the present disclosure, the control module 30 is configured to, when the cooking stage is the air-frying temperature rise stage: determine a first predetermined cooking temperature and a second predetermined cooking time period at the air-frying temperature rise stage; obtain a cavity temperature of the cooking device; and control the air frying module based on the cavity temperature, the first predetermined cooking temperature and the second predetermined cooking time period.

In some embodiments of the present disclosure, the control module 30 is configured to, in the second predetermined cooking time period: control the air frying module to operate when the cavity temperature is smaller than or equal to a difference between the first predetermined cooking temperature and a first temperature threshold; and prohibit the air frying module from operating when the cavity temperature is greater than or equal to a sum of the first predetermined cooking temperature and the first temperature threshold.

In some embodiments of the present disclosure, the first predetermined cooking temperature ranges from 160° C. to 260° C.; and the second predetermined cooking time period ranges from 40% t to 65% t, where t represents the total cooking time period.

In some embodiments of the present disclosure, the control module 30 is configured to switch the cooking stage to the browning and crusting stage, subsequent to completion of the controlling the air frying module based on the cavity temperature, the first predetermined cooking temperature and the second predetermined cooking time period.

In some embodiments of the present disclosure, the control module 30 is configured to, when the cooking stage is the browning and crusting stage: determine a second predetermined cooking temperature and a third predetermined cooking time period at the browning and crusting stage; obtain a cavity temperature of the cooking device; and control the air frying module based on the cavity temperature, the second predetermined cooking temperature and the third predetermined cooking time period.

In some embodiments of the present disclosure, the control module 30 is configured to, in the third predetermined cooking time period: control the air frying module to operate when the cavity temperature is smaller than or equal to a difference between the second predetermined cooking temperature and a second temperature threshold; and prohibit the air frying module from operating when the cavity temperature is greater than or equal to a sum of the second predetermined cooking temperature and the second temperature threshold.

In some embodiments of the present disclosure, the second predetermined cooking temperature ranges from 140° C. to 250° C.; and the third predetermined cooking time period ranges from 15% t to 40% t, where t represents the total cooking time period.

In some embodiments of the present disclosure, the control module 30 is further configured to switch the cooking stage to the microwave quick-heating stage, subsequent to completion of the controlling the air frying module based on the cavity temperature, the second predetermined cooking temperature and the third predetermined cooking time period.

In some embodiments of the present application, the control module 30 is configured to, when the cooking stage is the cavity temperature rise stage: determine a third predetermined cooking temperature and a fourth predetermined cooking time period at the cavity temperature rise stage; obtain a cavity temperature of the cooking device; and control the air frying module based on the cavity temperature, the third predetermined cooking temperature and the fourth predetermined cooking time period.

In some embodiments of the present disclosure, the control module 30 is configured to, in the fourth predetermined cooking time period: control the air frying module to operate when the cavity temperature is smaller than or equal to a difference between the third predetermined cooking temperature and a third temperature threshold; and prohibit the air frying module from operating when the cavity temperature is greater than or equal to a sum of the third predetermined cooking temperature and the third temperature threshold.

In some embodiments of the present disclosure, the third predetermined cooking temperature ranges from 80° C. to 250° C.; and the fourth predetermined cooking time period ranges from 20% t to 35% t, where t represents the total cooking time period.

In some embodiments of the present disclosure, when the cooking stage includes a cavity temperature rise stage, a cooking time period in the air-frying temperature rise stage ranges from 20% t to 30% t, where t represents the total cooking time period.

In some embodiments of the present disclosure, the total cooking time period is determined based on the weight of the food material and ranges from 8 min to 40 min.

It should be noted that other specific implementations of the control apparatus for the cooking device according to the embodiments of the present disclosure can be found in the specific implementations of the control method for the cooking device of the above-mentioned embodiments of the present disclosure, and details thereof are not repeated herein to reduce redundancy.

In summary, in the control apparatus for the cooking device according to the embodiments of the present disclosure, by controlling the air frying module or the microwave module based on the cooking stage and the cooking parameter, the dehydration rate of the food material can be enhanced, cooking of the food material can be further accelerated, and the cooking time period can be shorten, to achieve the cooking effect of the food material with the crispy exterior and tender interior, and thus to improve the user experience. In addition, other compositions and functions of the cooking device of the embodiments of the present disclosure, and details thereof are not repeated herein to reduce redundancy.

1. A control method for a cooking device, the cooking device comprising an air frying module and a microwave module, the method comprising:
obtaining a characteristic parameter of a food material and a cooking stage of the cooking device;
determining a cooking parameter of the cooking device based on the characteristic parameter of the food material; and
controlling the air frying module or the microwave module based on the cooking stage and the cooking parameter to accelerate cooking of the food material.

2. The control method according to claim 1, wherein:
the characteristic parameter of the food material comprises a type and a weight of the food material;
the cooking parameter comprises predetermined cooking power, a predetermined cooking temperature, a total cooking time period, and a cavity temperature of the cooking device; and
the cooking stage comprises a microwave quick-heating stage, an air-frying temperature rise stage, and a browning and crusting stage.

3. The control method according to claim 2, wherein said controlling the air frying module or the microwave module based on the cooking stage and the cooking parameter comprises, when the cooking stage is the microwave quick-heating stage:
determining a first predetermined cooking time period at the microwave quick-heating stage, and determining first predetermined cooking power at the microwave quick-heating stage based on the type of the food material; and
controlling the microwave module to operate at the first predetermined cooking power for the first predetermined cooking time period.

4. The control method according to claim 3, wherein:
the first predetermined cooking power ranges from 200 W to 1400 W; and
the first predetermined cooking time period ranges from 15% t to 35% t, where t represents the total cooking time period.

5. The control method according to claim 2, wherein said controlling the air frying module or the microwave module based on the cooking stage and the cooking parameter comprises, when the cooking stage is the air-frying temperature rise stage:
determining a first predetermined cooking temperature and a second predetermined cooking time period at the air-frying temperature rise stage;
obtaining a cavity temperature of the cooking device; and
controlling the air frying module based on the cavity temperature, the first predetermined cooking temperature and the second predetermined cooking time period.

6. The control method according to claim 5, wherein said controlling the air frying module based on the cavity temperature, the first predetermined cooking temperature and the second predetermined cooking time period comprises, in the second predetermined cooking time period:
controlling the air frying module to operate when the cavity temperature is smaller than or equal to a difference between the first predetermined cooking temperature and a first temperature threshold; and
prohibiting the air frying module from operating when the cavity temperature is greater than or equal to a sum of the first predetermined cooking temperature and the first temperature threshold.

7. The control method according to claim 6, wherein:
the first predetermined cooking temperature ranges from 160° C. to 260° C.; and
the second predetermined cooking time period ranges from 40% t to 65% t, where t represents the total cooking time period.

8. The control method according to claim 5, further comprising, subsequent to completion of said controlling the air frying module based on the cavity temperature, the first predetermined cooking temperature and the second predetermined cooking time period:
switching the cooking stage to the browning and crusting stage.

9. The control method according to claim 2, wherein said controlling the air frying module or the microwave module based on the cooking stage and the cooking parameter comprises, when the cooking stage is the browning and crusting stage:
determining a second predetermined cooking temperature and a third predetermined cooking time period at the browning and crusting stage;
obtaining a cavity temperature of the cooking device; and
controlling the air frying module based on the cavity temperature, the second predetermined cooking temperature and the third predetermined cooking time period.

10. The control method according to claim 9, wherein said controlling the air frying module based on the cavity temperature, the second predetermined cooking temperature and the third predetermined cooking time period comprises, in the third predetermined cooking time period:
controlling the air frying module to operate when the cavity temperature is smaller than or equal to a difference between the second predetermined cooking temperature and a second temperature threshold; and
prohibiting the air frying module from operating when the cavity temperature is greater than or equal to a sum of the second predetermined cooking temperature and the second temperature threshold.

11. The control method according to claim 10, wherein:
the second predetermined cooking temperature ranges from 140° C. to 250° C.; and
the third predetermined cooking time period ranges from 15% t to 40% t, where t represents the total cooking time period.

12. The control method according to claim 9, further comprising, subsequent to completion of said controlling the air frying module based on the cavity temperature, the second predetermined cooking temperature and the third predetermined cooking time period:
switching the cooking stage to the microwave quick-heating stage.

13. The control method according to claim 2, wherein:
the cooking stage further comprises a cavity temperature rise stage; and
said controlling the air frying module or the microwave module based on the cooking stage and the cooking parameter comprises, when the cooking stage is the cavity temperature rise stage:
determining a third predetermined cooking temperature and a fourth predetermined cooking time period at the cavity temperature rise stage;
obtaining a cavity temperature of the cooking device; and
controlling the air frying module based on the cavity temperature, the third predetermined cooking temperature and the fourth predetermined cooking time period.

14. The control method according to claim 13, wherein said controlling the air frying module based on the cavity temperature, the third predetermined cooking temperature and the fourth predetermined cooking time period comprises, in the fourth predetermined cooking time period:
controlling the air frying module to operate when the cavity temperature is smaller than or equal to a difference between the third predetermined cooking temperature and a third temperature threshold; and
prohibiting the air frying module from operating when the cavity temperature is greater than or equal to a sum of the third predetermined cooking temperature and the third temperature threshold.

15. The control method according to claim 14, wherein:
the third predetermined cooking temperature ranges from 80° C. to 250° C.; and
the fourth predetermined cooking time period ranges from 20% t to 35% t, where t represents the total cooking time period.

16. The control method according to claim 13, wherein a cooking time period in the air-frying temperature rise stage ranges from 20% t to 30% t, where t represents the total cooking time period.

17. The control method according to claim 2, wherein the total cooking time period is determined based on the weight of the food material and ranges from 8 min to 40 min.

18. A computer-readable storage medium, having a control program for a cooking device stored thereon, wherein the control program for the cooking device, when executed by a processor, implements the control method for the cooking device according to claim 1

19. A cooking device, comprising:
a memory;
a processor; and
a control program for a cooking device stored on the memory and executable on the processor, wherein the cooking device comprising an air frying module and a microwave module, and wherein the processor, when executing the control program, cause the processor:
obtain a characteristic parameter of a food material and a cooking stage of the cooking device,
determine a cooking parameter of the cooking device based on the characteristic parameter of the food material, and
control the air frying module or the microwave module based on the cooking stage and the cooking parameter to accelerate cooking of the food material.

20. A control apparatus for a cooking device, the cooking device comprising an air frying module and a microwave module, the device comprising:
an obtaining module configured to obtain a characteristic parameter of a food material and a cooking stage of the cooking device;
a determining module configured to determine a cooking parameter of the cooking device based on the characteristic parameter of the food material; and
a control module configured to control the air frying module or the microwave module based on the cooking stage and the cooking parameter to accelerate cooking of the food material.
